(19) United States
(12) Patent Application Publication
(10) Pub. No.: US 2022/0124217 A1
(43) Pub. Date: Apr. 21, 2022

(54) ELECTRONIC APPARATUS, SYSTEM, METHOD FOR MANAGING DESTINATION INFORMATION, AND NON-TRANSITORY RECORDING MEDIUM

(71) Applicant: Tohru Sasaki, KANAGAWA (JP)

(72) Inventor: Tohru Sasaki, KANAGAWA (JP)

(73) Assignee: Ricoh Company, Ltd., Tokyo (JP)

(21) Appl. No.: 17/448,566

(22) Filed: Sep. 23, 2021

(30) Foreign Application Priority Data
Oct. 19, 2020 (JP) 2020-175620

(51) Int. Cl. H04N 1/32; H04N 1/00

(52) U.S. Cl. CPC H04N 1/32122; H04N 1/00408; H04N 1/00517; H04N 1/3209

(57) ABSTRACT

An electronic apparatus includes circuitry that selects at least one destination information set for transmission from a plurality of address books each holding a plurality of destination information sets. In response to reception of a notification of a change in one of the plurality of address books, the circuitry determines whether the selected at least one destination information set includes a destination information set selected from the one of the plurality of address books corresponding to the notification of the change. Based on a determination that the selected at least one destination information set includes the destination information set selected from the one of the plurality of address books corresponding to the notification of the change, the circuitry resets the selected at least one destination information set.

### CROSS-REFERENCE TO RELATED APPLICATION

This patent application is based on and claims priority pursuant to 35 U.S.C. § 119(a) to Japanese Patent Application No. 2020-175620, filed on Oct. 19, 2020 in the Japan Patent Office, the entire disclosure of which is hereby incorporated by reference herein.

### BACKGROUND

### Technical Field

The present invention relates to an electronic apparatus, a system, a method for managing destination information, and a non-transitory recording medium.

### Description of the Related Art

In recent years, with an increase in the volume of destination information to be registered in an apparatus, managing a large volume of destination information in the apparatus involves a high-capacity memory. There is an apparatus that causes an external apparatus to manage the destination information and acquires therefrom the destination information for use as necessary.

In a typical image forming apparatus, the destination information used as the destination in a transmission process such as facsimile (FAX) transmission is managed in an address book. When a user instructs the image forming apparatus to perform the transmission process, the user selects the destination information from the address book. The image forming apparatus uses an internal address book managed inside the image forming apparatus and an external address book managed outside the image forming apparatus. The destination information managed in the internal address book and the external address book may be changed by the user, for example.

In the image forming apparatus, when the destination information managed in the internal address book or the external address book is changed by the user, for example, the destination information being selected from the address books is reset to prevent transmission to a wrong destination. In the image forming apparatus allowing the user to select the destination information from the multiple address books, however, the currently selected destination information is reset even if the change is in the address book from which the destination information has not been selected.

### SUMMARY

In one embodiment of this invention, there is provided an electronic apparatus that includes, for example, circuitry. The circuitry selects at least one destination information set for transmission from a plurality of address books each holding a plurality of destination information sets. In response to reception of a notification of a change in one of the plurality of address books, the circuitry determines whether the selected at least one destination information set includes a destination information set selected from the one of the plurality of address books corresponding to the notification of the change. Based on a determination that the selected at least one destination information set includes the destination information set selected from the one of the plurality of address books corresponding to the notification of the change, the circuitry resets the selected at least one destination information set.

In one embodiment of this invention, there is provided a system that includes, for example, the above-described electronic apparatus and an external address book. The electronic apparatus further includes a memory that stores a first address book included in the plurality of address books. In response to reception of an update request from a remote site, the circuitry receives the notification of the change in the one of the plurality of address books. The notification of the change includes an address book type of the first address book and a change type of a change in the plurality of destination information sets. The plurality of address books further include a second address book managed by the external address book management apparatus. The circuitry receives the notification of the change in the one of the plurality of address books from the external address book management apparatus in response to reception by the external address book management apparatus of an update request from a remote site. The notification of the change includes an address book type of the second address book and the change type of the change in the plurality of destination information sets.

In one embodiment of this invention, there is provided a method for managing destination information that includes, for example, selecting at least one destination information set for transmission from a plurality of address books each holding a plurality of destination information sets, determining, in response to reception of a notification of a change in one of the plurality of address books, whether the selected at least one destination information set includes a destination information set selected from the one of the plurality of address books corresponding to the notification of the change, and based on a determination that the selected at least one destination information set includes the destination information set selected from the one of the plurality of address books corresponding to the notification of the change, resetting the selected at least one destination information set.

In one embodiment of this invention, there is provided a non-transitory recording medium storing a plurality of instructions which, when executed by one or more processors, cause the processors to perform the above-described method for managing destination information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration example of an information processing system of an embodiment of the present invention;

FIG. 2 is a diagram illustrating an example of the hardware configuration of a computer included in the information processing system of the embodiment;

FIG. 3 is a diagram illustrating an example of the hardware configuration of a multifunction peripheral/product/printer included in the information processing system of the embodiment;

FIG. 4 is a diagram illustrating an example of the functional configuration of the information processing system of the embodiment;

FIG. 5A is a diagram illustrating an example of an internal address book data management table of the embodiment;

FIG. 5B is a diagram illustrating an example of an external address book data management table of the embodiment;

FIG. 6 is a diagram illustrating a configuration example of a selected destination management table of the embodiment;

FIG. 7 is a sequence diagram illustrating an example of a process of the embodiment to update the selected destination management table;

FIG. 8 is a sequence diagram illustrating an example of a process of the embodiment performed in response to notification of an internal address book data change event;

FIG. 9 is a sequence diagram illustrating an example of a process of the embodiment performed in response to notification of an external address book data change event;

FIG. 10 is a flowchart illustrating an example of a reset necessity determination process of the embodiment; and

FIG. 11 is a flowchart illustrating another example of the reset necessity determination process of the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An embodiment of the present invention will be described below with reference to the accompanying drawings.

A system configuration of an information processing system of the embodiment will be described.

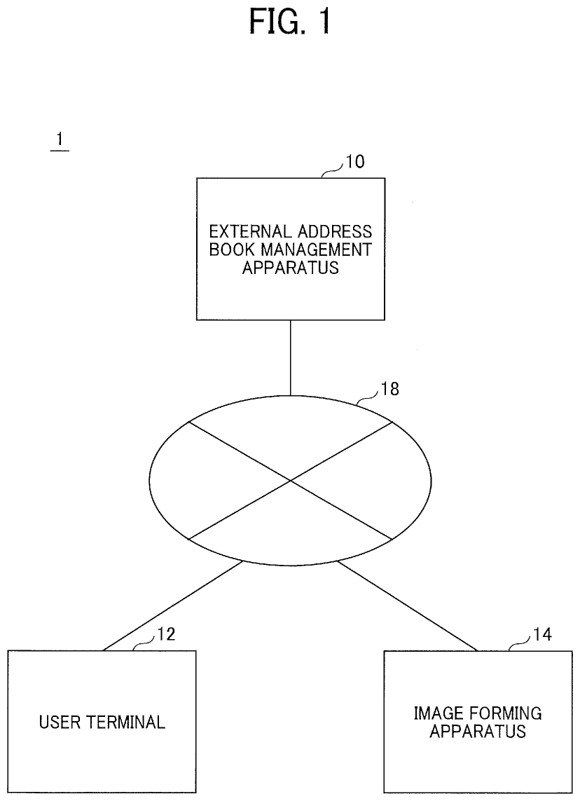

FIG. 1 is a diagram illustrating a configuration example of an information processing system 1 of the embodiment. The information processing system 1 illustrated in FIG. 1 includes an external address book management apparatus 10, a user terminal 12, and an image forming apparatus 14, which communicate with each other via a network 18. The network 18 is a telephone network, the Internet, or a local area network (LAN), for example.

The external address book management apparatus 10 is implemented by at least one information processing apparatus (server). Alternatively, the external address book management apparatus 10 may be implemented by a cloud computing platform. The external address book management apparatus 10 manages an external address book. The external address book is an example of an address book managed outside the image forming apparatus 14. The external address book holds destination information used as the destination in a transmission process. The external address book management apparatus 10 receives a request from a remote site to change the external address book, and changes the external address book.

The image forming apparatus 14 is an example of an electronic apparatus that selects at least one destination information set from address books, and performs the transmission process such as FAX transmission with the destination information set. The image forming apparatus 14 is a FAX machine, a scanner, or a multifunction peripheral/product/printer (MFP), for example. The image forming apparatus 14 manages an internal address book. The internal address book is an example of an address book managed inside the image forming apparatus 14. The internal address book holds the destination information used as the destination in the transmission process. The image forming apparatus 14 receives a request from a remote site to change the internal address book, and changes the internal address book. The image forming apparatus 14 further performs the transmission process such as the FAX transmission with the destination information selected from the internal address book and the external address book. The internal address book is an example of a first address book, and the external address book is an example of a second address book.

In response to reception of a notification of a change in at least one of the internal address book and the external address book, the image forming apparatus 14 determines whether the destination information being selected (hereinafter referred to as the currently selected destination information) should be reset, as described later. If it is determined that the currently selected destination information should be reset, the image forming apparatus 14 executes a process of resetting the currently selected destination information. If it is determined unnecessary to reset the currently selected destination information, the image forming apparatus 14 does not execute the process of resetting the currently selected destination information.

The user terminal 12 receives an operation performed by a user to change the internal address book or the external address book. Based on the received user operation to change the internal address book or the external address book, the user terminal 12 transmits a request to change the internal address book or the external address book. The user operation to change the internal address book may also be received by the image forming apparatus 14 via an operation panel of the image forming apparatus 14.

The user terminal 12 is a personal computer (PC), for example. Alternatively, the user terminal 12 may be a mobile phone, smartphone, tablet terminal, gaming system, or a personal digital assistant (PDA), for example.

The configuration of the information processing system 1 illustrated in FIG. 1 is illustrative. For example, the information processing system 1 may be configured with at least part of the functions of the image forming apparatus 14 being implemented by an apparatus other than the image forming apparatus 14, such as a server. Further, the information processing system 1 may include a plurality of external address book management apparatuses 10 to handle a plurality of external address books, each of which is identifiable by later-described address book type.

A hardware configuration of the information processing system 1 will be described.

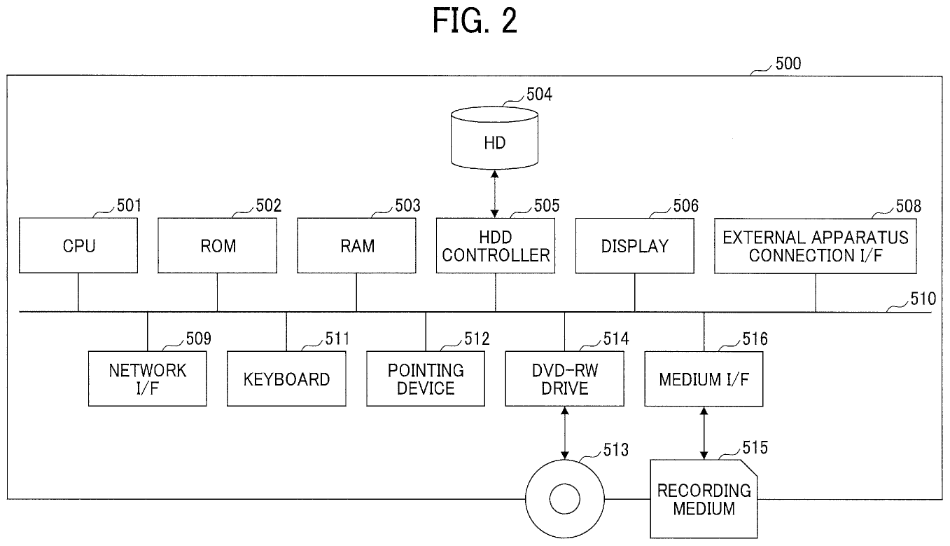

The external address book management apparatus 10 illustrated in FIG. 1 is implemented by a computer 500 with the hardware configuration illustrated in FIG. 2, for example. The user terminal 12 illustrated in FIG. 1 may also be implemented by the computer 500 with the hardware configuration in FIG. 2, for example. FIG. 2 is a diagram illustrating an example of the hardware configuration of the computer 500 of the embodiment.

The computer 500 includes a central processing unit (CPU) 501, a read only memory (ROM) 502, a random access memory (RAM) 503, a hard disk (HD) 504, a hard disk drive (HDD) controller 505, a display 506, an external apparatus connection interface (I/F) 508, a network I/F 509, a data bus 510, a keyboard 511, a pointing device 512, a digital versatile disc-rewritable (DVD-RW) drive 514, and a medium I/F 516.

The CPU 501 controls the overall operation of the computer 500 in accordance with a program. The ROM 502 stores a program used to drive the CPU 501, such as an initial program loader (IPL). The RAM 503 is used as a work area for the CPU 501. The HD 504 stores various data of programs, for example. The HDD controller 505 controls writing and reading of various data to and from the HD 504 under the control of the CPU 501.

The display 506 displays various information such as a cursor, menus, windows, text, and images. The external apparatus connection I/F 508 is an interface for connecting the computer 500 to various external apparatuses. The external apparatuses in this case include a universal serial bus (USB) memory, for example. The network I/F 509 is an interface for performing data communication via the network 18. The data bus 510 includes an address bus and a data bus for electrically connecting the CPU 501 and the other components to each other.

The keyboard 511 is an input device including a plurality of keys for inputting text, numerical values, and various instructions, for example. The pointing device 512 is an input device used to select and execute various instructions, select a processing target, and move the cursor, for example. The DVD-RW drive 514 controls writing and reading of various data to and from a DVD-RW 513 as an example of a removable recording medium. The removable recording medium is not limited to the DVD-RW, and may be a DVD-recordable (DVD-R), for example. The medium I/F 516 controls writing (i.e., storage) and reading of data to and from a recording medium 515 such as a flash memory.

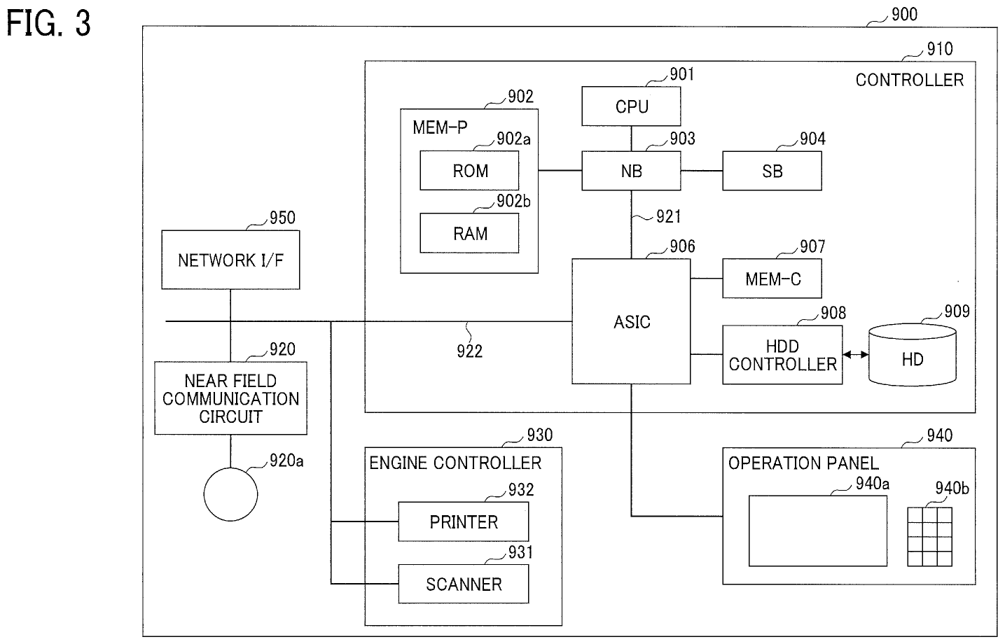

The image forming apparatus 14 illustrated in FIG. 1 is implemented by an MFP 900 with the hardware configuration illustrated in FIG. 3, for example. FIG. 3 is a diagram illustrating an example of the hardware configuration of the MFP 900 of the embodiment.

The MFP 900 in FIG. 3 includes a controller 910, a near field communication circuit 920, an engine controller 930, an operation panel 940, and a network I/F 950.

The controller 910 includes a CPU 901 as a major component of a computer forming the MFP 900, a system memory (MEM-P) 902, a north bridge (NB) 903, a south bridge (SB) 904, an application specific integrated circuit (ASIC) 906, a local memory (MEM-C) 907 serving as a storage unit, an HDD controller 908, and an HD 909 serving as a storage unit. The NB 903 and the ASIC 906 are connected to each other by an accelerated graphics port (AGP) bus 921.

The CPU 901 is a control device that performs the overall control of the MFP 900. The NB 903 is s bridge for connecting the CPU 901, the MEM-P 902, the SB 904, and the AGP bus 921 to each other. The NB 903 includes a memory controller that controls data writing and reading to and from the MEM-P 902, a peripheral component interconnect (PCI) master, and an AGP target.

The MEM-P 902 includes a ROM 902a and a RAM 902b. The ROM 902a is a memory for storing programs and data for implementing the functions of the controller 910. The RAM 902b is used as a memory in deploying a program or data or as a rendering memory in memory printing, for example. Each of the programs stored in the ROM 902a may be provided as recorded on a computer readable recording medium, such as a compact disc-ROM (CD-ROM), a CD-recordable (CD-R), or a DVD, in an installable or executable file format.

The SB 904 is a bridge for connecting the NB 903 to a PCI device or a peripheral device. The ASIC 906 is an integrated circuit (IC) for image processing, which includes hardware components for image processing. The ASIC 906 functions as a bridge for connecting the AGP bus 921, a PCI bus 922, the HDD controller 908, and the MEM-C 907 to each other.

The ASIC 906 includes a PCI target, an AGP master, an arbiter (ARB) forming a core of the ASIC 906, a memory controller for controlling the MEM-C 907, a plurality of direct memory access controllers (DMACs) that perform processes such as the rotation of image data with a hardware logic, and a PCI unit that transfers data to and from a scanner 931 or a printer 932 of the engine controller 930 via the PCI bus 922. The ASIC 906 may be connected to an interface conforming to a standard such as USB or institute of electrical and electronics engineers (IEEE) 1394.

The MEM-C 907 is a local memory used as a copy image buffer and a code buffer. The HD 909 is a storage device for storing image data, font data for use in printing, and form data. The HDD controller 908 controls data writing and reading to and from the HD 909 under the control of the CPU 901. The AGP bus 921 is a bus interface for a graphics accelerator card proposed to speed up graphics processing. The AGP bus 921 enables the graphics accelerator card to directly access the MEM-P 902 with a high throughput, thereby implementing a high-speed graphics accelerator card.

The near field communication circuit 920, which is equipped with an antenna 920a, is a communication circuit conforming to a standard such as near field communication (NFC) or Bluetooth (registered trademark).

The engine controller 930 includes the scanner 931 and the printer 932. The operation panel 940 includes a panel display 940a and an operation panel 940b. The panel display 940a is implemented by a touch panel, for example, to display the current setting values and a selection screen and receive an input from an operator (i.e., user). The operation panel 940b includes keys such as numeric keys for receiving the setting values of conditions related to image formation such as a density setting condition and a start key for receiving a copy start instruction.

The controller 910 controls the entire MFP 900 to control rendering, communication, and input via the operation panel 940, for example. Each of the scanner 931 and the printer 932 includes an image processing device that performs processes such as error diffusion and gamma conversion.

With an application switch key included in the operation panel 940, the function of the MFP 900 is sequentially switched to a document box function, a copier function, a scanner function, a printer function, and a FAX function to select a desired function. When the document box function is selected, the MFP 900 is switched to a document box mode. When the copier function is selected, the MFP 900 is switched to a copier mode. When the scanner function is selected, the MFP 900 is switched to a scanner mode. When the printer function is selected, the MFP 900 is switched to a printer mode. When the FAX function is selected, the MFP 900 is switched to a FAX mode.

The network I/F 950 is an interface for performing data communication via the network 18. The near field communication circuit 920 and the network I/F 950 are electrically connected to the ASIC 906 via the PCI bus 922.

The MFP 900 may use authentication with an IC card. In this case, an IC card reader is built in or externally attached to the MFP 900. Via wireless communication, the MFP 900 reads identification information unique to the IC card from a radio frequency (RF) tag embedded in the IC card. The IC card may be built in a smart device such as a smartphone. The MFP 900 may use a device other than the IC card reader, such as a biometric authentication device using fingerprint, palm print, iris, or face recognition or a bar code reader.

A functional configuration of the information processing system 1 of the embodiment will be described.

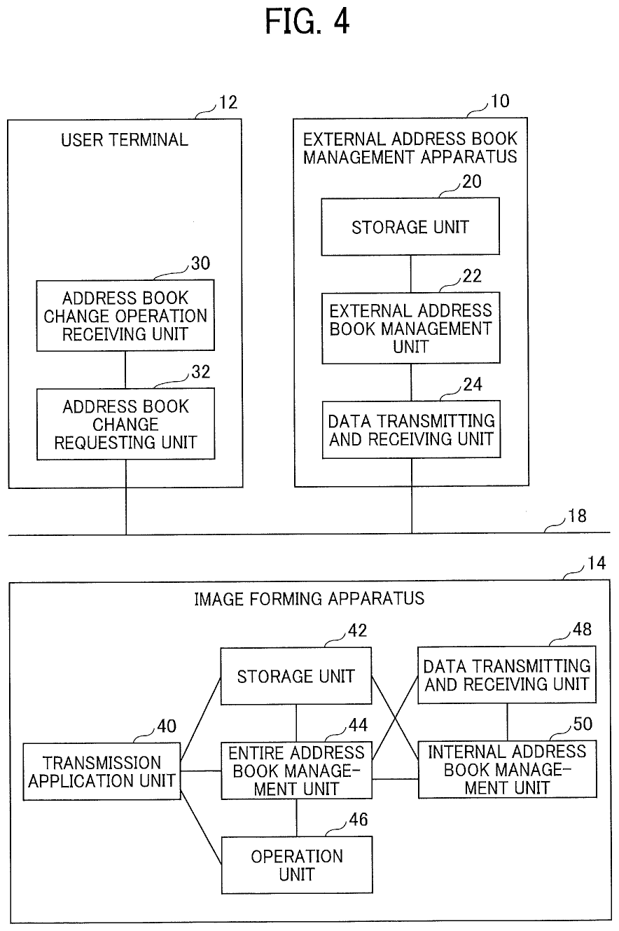

The information processing system 1 of the embodiment is implemented by the functional configuration illustrated in FIG. 4, for example. FIG. 4 is a diagram illustrating an example of the functional configuration of the information processing system 1 of the embodiment. In the functional configuration of FIG. 4, components unnecessary for the description of the embodiment are omitted as appropriate.

In FIG. 4, the external address book management apparatus 10 includes a storage unit 20, an external address book management unit 22, and a data transmitting and receiving unit 24. The storage unit 20 stores the external address book. The storage unit 20 is implemented by a command from the CPU 501, the HDD controller 505, and the HD 504 in FIG. 2, for example.

The external address book management unit 22 manages the destination information held in the external address book. The external address book management unit 22 is implemented by, for example, the CPU 501 in FIG. 2 executing the process according to a program by using the RAM 503 as a work area.

Via the network 18, the data transmitting and receiving unit 24 transmits the destination information held in the external address book to the user terminal 12 or the image forming apparatus 14, and receives therefrom the destination information to be held in the external address book. The data transmitting and receiving unit 24 is implemented by a command from the CPU 501 and the network I/F 509 in FIG. 2, for example.

In FIG. 4, the user terminal 12 includes an address book change operation receiving unit 30 and an address book change requesting unit 32. The address book change operation receiving unit 30 receives the operation performed by the user to change the external address book or the internal address book. The address book change operation receiving unit 30 is implemented by a command from the CPU 501, the display 506, the keyboard 511, and the pointing device 512 in FIG. 2, for example.

The address book change requesting unit 32 transmits the received user request to change the external address book or the internal address book to the external address book management apparatus 10 or the image forming apparatus 14. The address book change requesting unit 32 is implemented by a command from the CPU 501 and the network I/F 509 in FIG. 2, for example.

In FIG. 4, the image forming apparatus 14 includes a transmission application unit 40, a storage unit 42, an entire address book management unit 44, an operation unit 46, a data transmitting and receiving unit 48, and an internal address book management unit 50. The transmission application unit 40 processes an application program for a transmission function of a scanner or FAX machine, for example. The transmission application unit 40 is implemented by, for example, the CPU 901 in FIG. 3 executing the process according to a program by using the RAM 902b as a work area.

The storage unit 42 stores the internal address book and selected destination information. The storage unit 42 further stores data for executing a job and apparatus information, for example. The storage unit 42 is implemented by a command from the CPU 901, the HDD controller 908, and the HD 909 in FIG. 3, for example.

The entire address book management unit 44 manages the internal address book, the external address book, and the selected destination information. The entire address book management unit 44 receives an address book change notification (also referred to as address book change event notification), and performs reset necessity determination to determine whether the selected destination information should be reset. The entire address book management unit 44 is implemented by, for example, the CPU 901 in FIG. 3 executing the process according to a program by using the RAM 902b as a work area.

The operation unit 46 receives a user operation performed on the image forming apparatus 14, and displays the processing status of the image forming apparatus 14. For example, the operation unit 46 receives a user operation of selecting the destination information from the external address book or the internal address book. The operation unit 46 is implemented by a command from the CPU 901 and the operation panel 940 in FIG. 3, for example.

Via the network 18, the data transmitting and receiving unit 48 transmits the destination information to be held in the external address book to the external address book management apparatus 10, and receives the destination information held in the external address book from the external address book management apparatus 10. Further, via the network 18, the data transmitting and receiving unit 48 transmits the destination information held in the internal address book to the user terminal 12, and receives the destination information to be held in the internal address book from the user terminal 12. The data transmitting and receiving unit 48 is implemented by a command from the CPU 901 and the network I/F 950 in FIG. 3, for example.

The internal address book management unit 50 manages the destination information held in the internal address book. The internal address book management unit 50 is implemented by, for example, the CPU 901 in FIG. 3 executing the process according to a program by using the RAM 902b as a work area.

In the embodiment, the user operates the image forming apparatus 14 to select, as the selected destination information, the destination information to be used by the transmission application unit 40 from the destination information held in the internal address book or the external address book. The selected destination information may be set with a shortcut key, for example, or may be individually set before the use of the transmission function.

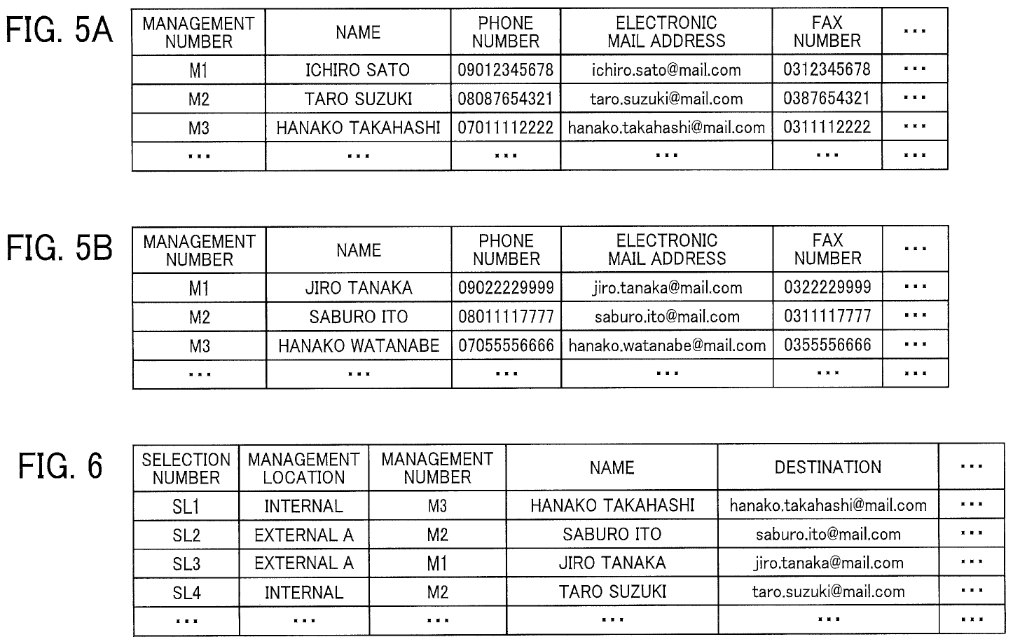

FIG. 5A is a diagram illustrating a configuration example of an internal address book data management table of the embodiment. FIG. 5B is a diagram illustrating a configuration example of an external address book data management table of the embodiment. The destination information of the internal address book is held in the internal address book data management table of FIG. 5A. The destination information of the external address book is held in the external address book data management table of FIG. 5B.

Each of the internal address book data management table and the external address book data management table contains management number, name, phone number, electronic mail address, and FAX number as exemplary items of the destination information of the address book. The items of the destination information in each of the internal address book data in FIG. 5A and the external address book data in FIG. 5B are illustrative, and may not match actual items of the destination information. For example, the FAX number included in the destination information of each of the internal address book data and the external address book data may be omitted. Further, the items of the destination information in the internal address book data management table may not match those in the external address book data management table. For example, the information processing system 1 of the embodiment may use internal address book data including the FAX number as an item of the destination information and external address book data not including the FAX number as an item of the destination information.

FIG. 6 is a diagram illustrating a configuration example of a selected destination management table of the embodiment. FIG. 6 illustrates an example of the selected destination management table. The selected destination information is held in the selected destination management table of FIG. 6.

The selected destination management table contains selection number, management location, management number, name, and destination as exemplary items of the selected destination information. With the transmission application unit 40, the user selects the destination information of the transmission destination. The entire address book management unit 44 uses the selected destination management table of FIG. 6 to manage the selected destination information selected by the user.

The selection number is identification information for identifying the destination information selected by the user. The management location is information indicating the address book in which the destination information selected by the user is managed. In FIG. 6, for example, the destination information corresponding to a selection number SL1 and the destination information corresponding to a selection number SL4 are managed in the internal address book. Further, the destination information corresponding to a selection number SL2 and the destination information corresponding to a selection number SL3 are managed in an external address book named as “external A.”

The management number represents the management number in the address book data management table managed in the address book at the corresponding management location. With the selected destination management table in FIG. 6, the entire address book management unit 44 identifies the address book (i.e., the address book data management table) in which the selected destination information is managed.

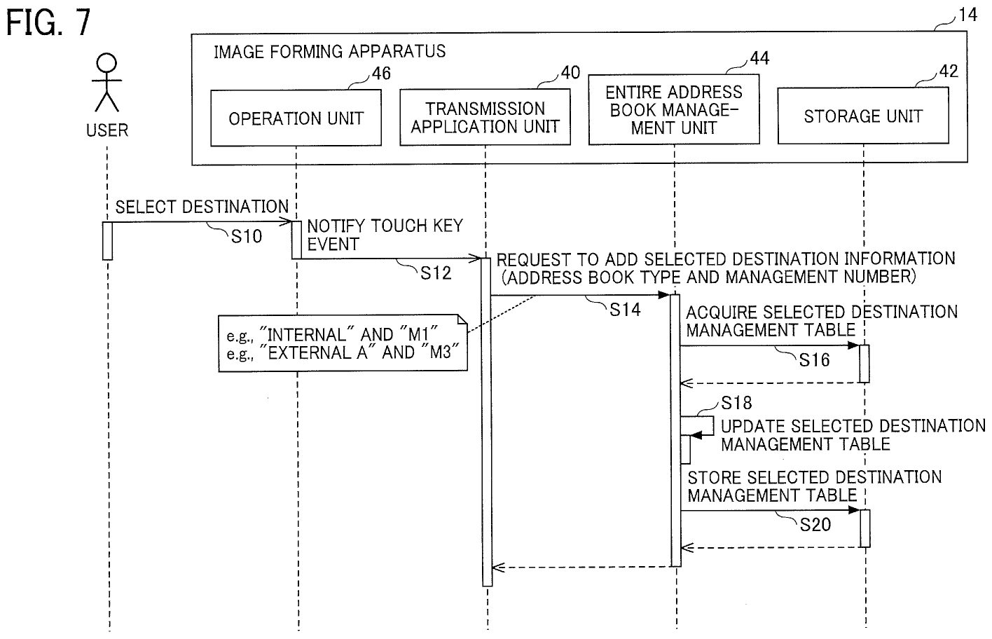

A process of updating the selected destination management table in the selection of the destination information is executed in accordance with the procedure illustrated in the sequence diagram of FIG. 7, for example. FIG. 7 is a sequence diagram illustrating an example of the process of updating the selected destination management table of the embodiment.

At step S10, the user selects a desired transmission destination from a list of destination information displayed on the operation unit 46 by the transmission application unit 40. The transmission application unit 40 displays the list of destination information by using the destination information of the internal address book (i.e., the internal address book data management table) in FIG. 5A and the destination information of the external address book (i.e., the external address book data management table) in FIG. 5B.

At step S12, the operation unit 46 notifies the transmission application unit 40 of a touch key event corresponding to the selection of the destination made at step S10. The notification at step S12 may be performed based on the operation of a hardware key.

At step S14, in response to the notification of the touch key event, the transmission application unit 40 identifies the selected destination information, and requests the entire address book management unit 44 to add the selected destination information to the selected destination management table. In the request at step S14 to add the selected destination information to the selected destination management table, the transmission application unit 40 specifies the address book type and the management number.

For example, in response to the user selection of the destination information registered with a management number M1 in the internal address book, the transmission application unit 40 specifies an address book type “internal” and the management number “M1.” Further, in response to the user selection of the destination information registered with a management number M3 in the external address book “external A,” the transmission application unit 40 specifies an address book type “external A” and the management number “M3.”

At step S16, the entire address book management unit 44 acquires the selected destination management table as illustrated in FIG. 6 from the storage unit 42.

At step S18, the entire address book management unit 44 performs an update process by adding the selected destination information requested to add at step S14 to the selected destination management table.

At step S20, the entire address book management unit 44 stores (i.e., saves) the selected destination management table updated at step S18 in the storage unit 42. As illustrated in FIG. 7, the selected destination information held in the selected destination management table is updated by the user performing, on the operation unit 46, an operation of selecting or cancelling the destination. Although a process performed by the entire address book management unit 44 to acquire the items “name” and “destination” in the selected destination management table of FIG. 6 is omitted in the sequence diagram of FIG. 7, the entire address book management unit 44 may acquire these items as necessary, or may specify the items at step S14, for example.

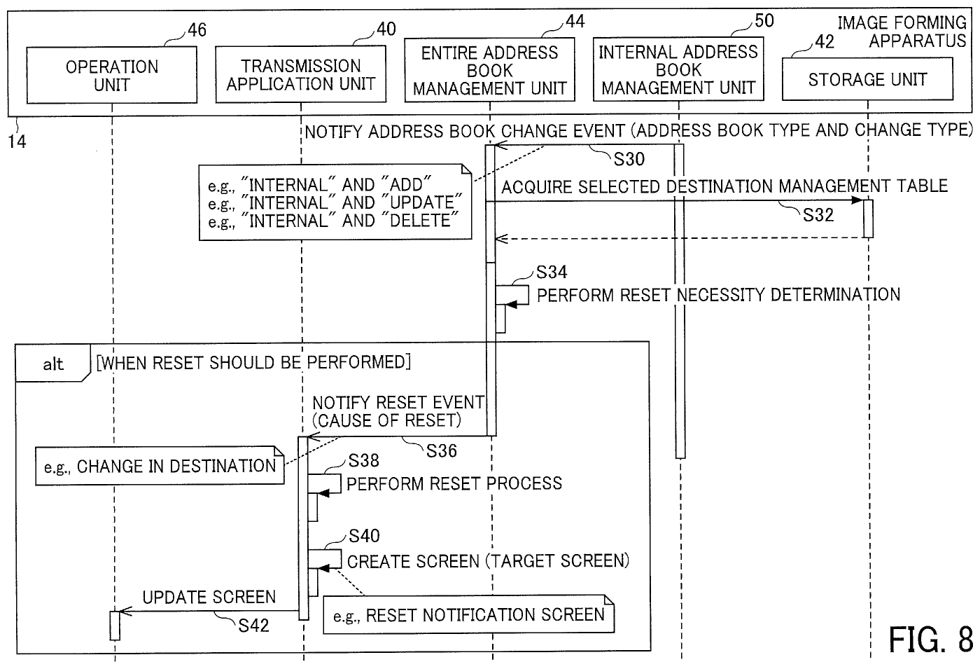

FIG. 8 is a sequence diagram illustrating an example of a process of the embodiment performed in response to notification of an internal address book data change event.

At step S30, in response to reception of an internal address book change request from a remote site, for example, the internal address book management unit 50 changes the internal address book data management table in FIG. 5A, for example. The internal address book management unit 50 then notifies the entire address book management unit 44 of the address book change event. In the notification of the address book change event at step S30, the internal address book management unit 50 specifies the address book type and the change type.

For example, if new destination information is added to the internal address book data management table, the internal address book management unit 50 specifies the address book type “internal” and a change type “add.” If the destination information already registered in the internal address book data management table is updated, the internal address book management unit 50 specifies the address book type “internal” and a change type “update.” If the destination information already registered in the internal address book data management table is deleted, the internal address book management unit 50 specifies the address book type “internal” and a change type “delete.”

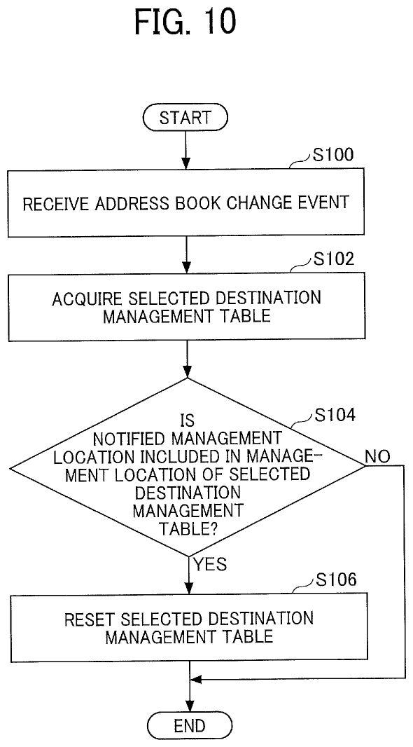

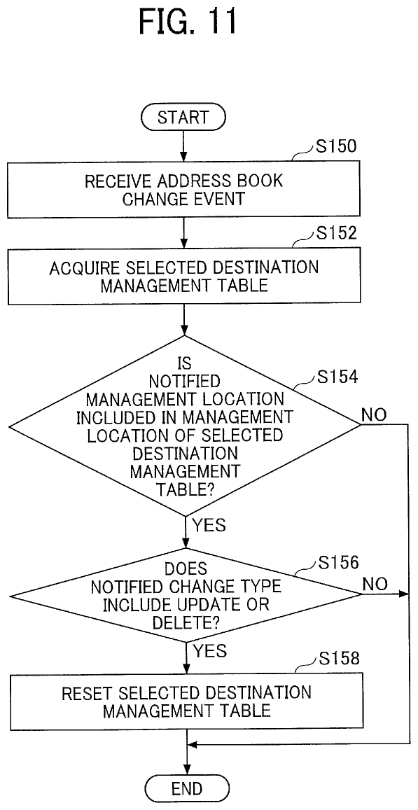

At step S32, the entire address book management unit 44 acquires the selected destination management table as illustrated in FIG. 6 from the storage unit 42. At step 34, the entire address book management unit 44 performs the reset necessity determination to determine whether the selected destination management table acquired at step S32 should be reset. Details of the reset necessity determination process at step S34 will be described later with FIGS. 10 and 11.

If it is determined at step S34 that the selected destination management table should be reset, the processes of steps S36 to S42 are performed. At step S36, the entire address book management unit 44 notifies the transmission application unit 40 of a reset event. In the notification of the reset event at step S36, the entire address book management unit 44 specifies the cause of the reset (e.g., a change in the destination).

At step S38, the transmission application unit 40 performs a reset process of resetting the selected destination management table to reset the currently selected destination information. At step S40, the transmission application unit 40 further creates a reset notification screen for notifying the user that the currently selected destination information has been reset owing to the change in the destination, for example. At step S42, the transmission application unit 40 causes the operation unit 46 to update the screen to display the reset notification screen.

As described above, according to the process in the sequence diagram of FIG. 8, in response to a change in the internal address book, whether the selected destination management table should be reset is determined. Then, if it is determined that the currently selected destination information should be reset, the reset process of resetting the currently selected destination information is performed.

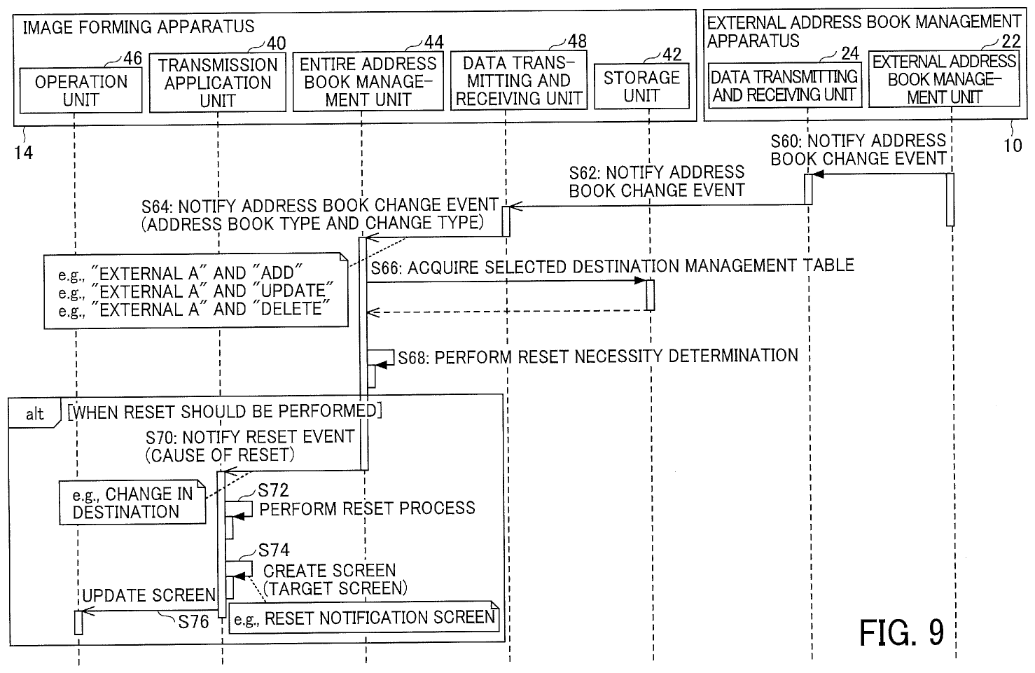

FIG. 9 is a sequence diagram illustrating an example of a process of the embodiment performed in response to notification of an external address book data change event.

In response to reception of an external address book change request from a remote site, for example, the external address book management unit 22 of the external address book management apparatus 10 changes the external address book data management table in FIG. 5B, for example. At steps S60 to S64, the external address book management unit 22 notifies the entire address book management unit 44 of the image forming apparatus 14 of the address book change event. In the notification of the address book change event at step S60, the external address book management unit 22 specifies the address book type and the change type.

For example, if new destination information is added to the external address book data management table, the external address book management unit 22 specifies the address book type “external A” and the change type “add.” If the destination information already registered in the external address book data management table is updated, the external address book management unit 22 specifies the address book type “external A” and the change type “update.” If the destination information already registered in the external address book data management table is deleted, the external address book management unit 22 specifies the address book type “external A” and the change type “delete.”

At step S66, the entire address book management unit 44 acquires the selected destination management table as illustrated in FIG. 6 from the storage unit 42. At step 68, the entire address book management unit 44 performs the reset necessity determination to determine whether the selected destination management table acquired at step S66 should be reset. Details of the reset necessity determination process at step S68 will be described later with FIGS. 10 and 11.

If it is determined at step S68 that the selected destination management table should be reset, the processes of steps S70 to S76 are performed. At step S70, the entire address book management unit 44 notifies the transmission application unit 40 of the reset event. In the notification of the reset event at step S70, the entire address book management unit 44 specifies the cause of the reset (e.g., a change in the destination).

At step S72, the transmission application unit 40 performs the reset process of resetting the selected destination management table to reset the currently selected destination information. At step S74, the transmission application unit 40 further creates the reset notification screen for notifying the user that the currently selected destination information has been reset owing to the change in the destination, for example. At step S76, the transmission application unit 40 causes the operation unit 46 to update the screen to display the reset notification screen.

As described above, according to the process in the sequence diagram of FIG. 9, in response to a change in the external address book, whether the selected destination management table should be reset is determined. Then, if it is determined that the currently selected destination information should be reset, the reset process of resetting the currently selected destination information is performed.

In the sequence diagram of FIG. 9, if the external address book data management table in FIG. 5B is changed, for example, the external address book management apparatus 10 notifies the entire address book management unit 44 of the image forming apparatus 14 of the address book change event. This notification of the address book change event to the entire address book management unit 44 of the image forming apparatus 14 from the external address book management apparatus 10 may be made as a response to periodic inquiring (i.e., polling) to the external address book management apparatus 10 from the image forming apparatus 14, for example.

FIG. 10 is a flowchart illustrating an example of the reset necessity determination process of the embodiment. At step S100, the entire address book management unit 44 of the image forming apparatus 14 receives the address book change event from the internal address book management unit 50 of the image forming apparatus 14 or from the external address book management unit 22 of the external address book management apparatus 10. At step S102, the entire address book management unit 44 acquires the selected destination management table as illustrated in FIG. 6 from the storage unit 42.

At step S104, the entire address book management unit 44 determines whether the management location from which the address book change event has been notified at step S100 is included in the item “management location” of the selected destination information held in the selected destination management table.

For example, if the address book change event has been notified from the internal address book management unit 50 at step S100, the entire address book management unit 44 determines at step S104 whether the selected destination management table contains the selected destination information in which the item “management location” is “internal.”

Further, if the address book change event has been notified from the external address book management unit 22 of the external address book management apparatus 10 at step S100, the entire address book management unit 44 determines at step S104 whether the selected destination management table contains the selected destination information in which the item “management location” is “external A.”

If it is determined that the management location from which the address book change event has been notified at step S100 is included in the item “management location” of the selected destination information in the selected destination management table (YES at step S104), the process of step S106 is performed. At step S106, the entire address book management unit 44 controls the transmission application unit 40 to reset the selected destination management table.

If it is determined that the management location from which the address book change event has been notified at step S100 is not included in the item “management location” of the selected destination information in the selected destination management table (NO at step S104), the entire address book management unit 44 skips the process of step S106. That is, the entire address book management unit 44 does not control the transmission application unit 40 to reset the selected destination management table.

The information processing system 1 of the embodiment holds, for each currently selected destination information, the information of the address book type indicating the address book in which the currently selected destination information is registered. In response to reception of the address book change event, the image forming apparatus 14 performs the reset process if the currently selected destination information includes the destination information selected from the changed address book. If the currently selected destination information does not include the destination information selected from the changed address book, on the other hand, the image forming apparatus 14 does not perform the reset process in response to reception of the address book change event.

If the destination information in the internal address book is not selected, therefore, the information processing system 1 of the embodiment avoids an unnecessary reset process when the internal address book is changed. Further, if the destination information in the external address book “external A” is not selected, the information processing system 1 of the embodiment avoids an unnecessary reset process when the external address book “external A” is changed.

In the process of the flowchart in FIG. 10, the address book type specified in the address book change event is used in the reset necessity determination. Alternatively, for example, the address book type and the change type specified in the address book change event may be used in the reset necessity determination, as illustrated in FIG. 11.

FIG. 11 is a flowchart illustrating another example of the reset necessity determination process of the embodiment. At step S150, the entire address book management unit 44 of the image forming apparatus 14 receives the address book change event from the internal address book management unit 50 of the image forming apparatus 14 or from the external address book management unit 22 of the external address book management apparatus 10. At step S152, the entire address book management unit 44 acquires the selected destination management table as illustrated in FIG. 6 from the storage unit 42.

At step S154, the entire address book management unit 44 determines whether the management location from which the address book change event has been notified at step S150 is included in the item “management location” of the selected destination information held in the selected destination management table.

If it is determined that the management location from which the address book change event has been notified at step S150 is included in the item “management location” of the selected destination information in the selected destination management table (YES at step S154), the entire address book management unit 44 performs the process of step S156. At step S156, the entire address book management unit 44 determines whether the change type specified in the address book change event at step S150 includes “update” or “delete.”

If it is determined that the change type specified in the address book change event at step S150 includes “update” or “delete” (YES at step S156), the entire address book management unit 44 performs the process of step S158. At step S158, the entire address book management unit 44 controls the transmission application unit 40 to reset the selected destination management table.

If the management location specified in the address book change event at step S150 is not included in the item “management location” of the selected destination information in the selected destination management table, the entire address book management unit 44 skips the process of step S158. That is, the entire address book management unit 44 does not control the transmission application unit 40 to reset the selected destination management table. Further, if the change type specified in the address book change event at step S150 does not include “update” or “delete” (NO at step S156), the entire address book management unit 44 skips the process of step S158. That is, the entire address book management unit 44 does not control the transmission application unit 40 to reset the selected destination management table.

In addition to the step processes in FIG. 10, the information processing system 1 of the embodiment determines whether the change type specified in the address book change event includes “update” or “delete” to determine whether the reset process should be performed. If the specified change type includes “update” or “delete,” the currently selected destination information may have been changed, and thus the image forming apparatus 14 performs the reset process of resetting the currently selected destination information. If the specified change type does not include “update” or “delete” but includes “add,” there is no possibility that the currently selected destination information has been changed, and thus the image forming apparatus 14 does not perform the reset process of resetting the currently selected destination information.

If the destination information in the internal address book is selected, therefore, the information processing system 1 of the embodiment avoids an unnecessary reset process when new destination information is added to the internal address book. Further, if the destination information in the external address book “external A” is selected, the information processing system 1 of the embodiment avoids an unnecessary reset process when new destination information is added to the external address book “external A.”

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An electronic apparatus comprising circuitry configured to
select at least one destination information set for transmission from a plurality of address books each holding a plurality of destination information sets,
in response to reception of a notification of a change in one of the plurality of address books, determine whether the selected at least one destination information set includes a destination information set selected from the one of the plurality of address books corresponding to the notification of the change, and
based on a determination that the selected at least one destination information set includes the destination information set selected from the one of the plurality of address books corresponding to the notification of the change, reset the selected at least one destination information set.

2. The electronic apparatus of claim 1, wherein the notification of the change in the one of the plurality of address books includes a change type of a change in the plurality of destination information sets, the change type being addition to, update of, or deletion from the plurality of destination information sets,
wherein based on the determination that the selected at least one destination information set includes the destination information set selected from the one of the plurality of address books corresponding to the notification of the change, the circuitry determines whether the change type of the change in the plurality of destination information sets includes at least one of the update of or the deletion from the plurality of destination information sets, and
wherein based on a determination that the change type of the change in the plurality of destination information sets includes the at least one of the update of or the deletion from the plurality of destination information sets, the circuitry resets the selected at least one destination information set.

3. The electronic apparatus of claim 2, wherein based on a determination that the change type of the change in the plurality of destination information sets includes the addition to the plurality of destination information sets, the circuitry avoids resetting the selected at least one destination information set.

4. The electronic apparatus of claim 1, further comprising a memory that stores a first address book included in the plurality of address books,
wherein in response to reception of an update request from a remote site, the circuitry receives the notification of the change in the one of the plurality of address books, the notification of the change including an address book type of the first address book and a change type of a change in the plurality of destination information sets.

5. The electronic apparatus of claim 4, wherein the plurality of address books further includes a second address book managed by an external address book management apparatus, and
wherein the circuitry receives the notification of the change in the one of the plurality of address books from the external address book management apparatus in response to reception by the external address book management apparatus of an update request from a remote site, the notification of the change including an address book type of the second address book and the change type of the change in the plurality of destination information sets.

6. The electronic apparatus of claim 1, wherein each of the plurality of destination information sets includes at least one of telephone number, electronic mail address, or facsimile number, and
wherein the circuitry transmits facsimile data with the selected at least one destination information set.

7. A system comprising:
the electronic apparatus of claim 5; and
an external address book management apparatus configured to manage a second address book included in the plurality of address books.

8. A method for managing destination information comprising:
selecting at least one destination information set for transmission from a plurality of address books each holding a plurality of destination information sets;
in response to reception of a notification of a change in one of the plurality of address books, determining whether the selected at least one destination information set includes a destination information set selected from the one of the plurality of address books corresponding to the notification of the change; and
based on a determination that the selected at least one destination information set includes the destination information set selected from the one of the plurality of address books corresponding to the notification of the change, resetting the selected at least one destination information set.

9. A non-transitory recording medium storing a plurality of instructions which, when executed by one or more processors, cause the processors to perform a method for managing destination information comprising:
selecting at least one destination information set for transmission from a plurality of address books each holding a plurality of destination information sets;
in response to reception of a notification of a change in one of the plurality of address books, determining whether the selected at least one destination information set includes a destination information set selected from the one of the plurality of address books corresponding to the notification of the change; and
based on a determination that the selected at least one destination information set includes the destination information set selected from the one of the plurality of address books corresponding to the notification of the change, resetting the selected at least one destination information set.
